(19) United States
(12) Patent Application Publication
(10) Pub. No.: US 2004/0107028 A1
(43) Pub. Date: Jun. 3, 2004

(54) Override protocol system for affording vehicle safety and for preventing hijacking

(76) Inventor: Anthony B. Catalano, Sugar Land, TX (US)

Correspondence Address: AL HARRISON, 1018 PRESTON STREET, SUITE 100, HOUSTON, TX, 77002, US

(21) Appl. No.: 10/683,591

(22) Filed: Oct. 10, 2003

Related U.S. Application Data
(60) Provisional application No. 60/430,400, filed on Dec. 3, 2002.

(51) Int. Cl. G05D 1/00

(52) U.S. Cl. 701/2; 340/573.1

(57) ABSTRACT

A methodology for preventing hijacking of surface vehicles by invoking an override means for taking control of such vehicles, when circumstances merit such drastic corrective action. If monitoring sensors indicate that exigent circumstances such as airplane hijacking are occurring, then action would be triggered from a central control to either disable the vehicle, dump fuel, shutdown engines, or otherwise override control thereof. This action would frustrate the hijackers' purpose and could save lives and minimize losses.

### RELATED APPLICATIONS

This application claims priority based upon Provisional U.S. Application Ser. No. 60/430,400 filed Dec. 3, 2002.

### TECHNICAL FIELD OF THE INVENTION

The present invention relates to vehicle safety, and, more particularly, relates to a methodology for preventing hijacking of aircraft, ships, buses and other commercial surface vehicles, trains, and the like, by invoking an override means for taking control of such aircraft, ships, or other means of commercial and public transportation, when circumstances merit such drastic corrective action.

### BACKGROUND OF THE INVENTION

It is unfortunate that thefts and hijackings have become all too common in modern day society. From the prevalent theft of automobiles and the like that are regularly perpetrated in communities throughout the United States, to the occasional high-profile hijacking of aircraft and ocean-going ships by terrorists or the like, citizens worldwide suffer from this horrible aspect of modern day society.

There have been many attempts to prevent such dastardly activities from being perpetrated, but with only limited success to date. For instance, Gabbard, in U.S. Pat. No. 6,124,805, teaches a remotely operated vehicle identification and disabling system. This system has a remotely operated transmitter device that sends a command shutdown message to a corresponding receiver that is located in the vehicle and integrated with one or more of its sub-systems. Satellite communications providing GPS may be used to monitor vehicle location.

In U.S. Pat. No. 5,917,405, Joao discloses a control apparatus that includes a remote transmitter means for transmitting a signal over a communication system and, upon activation by the owner or an authorized user or operator of the vehicle, a receiver integrated with a local computer can intercede in the normal operation of one or more of the vehicle's sub-systems. This control apparatus, upon receiving the proper signal from a remote controller, can interfere with normal vehicle operation by disabling the ignition sub-system, the fuel sub-system, etc. This control apparatus may also be used to monitor vehicle locations via a global positioning device and digitized map data, wherein this information may be shared with law enforcement personnel to track terrorism, thefts, and other crimes.

In U.S. Pat. No. 5,969,595, Schipper et al. disclose a location determination security system for a vehicle and for cargo transported on the vehicle. The cargo vehicle carries a transceiver that transmits a signal that allows a receiver to track the signal's characteristics—intensity, coding, and time of receipt. If this received signal violates a predetermined protocol or condition, then current cargo destination is compared with approved destinations. If the cargo destination is illegitimate, then an alarm is sounded. This system may be based upon GPS, LORAN, or other satellite or ground-based communications.

Zach, in U.S. Pat. No. 6,211,818, discloses a vehicle GPS-based tracking system for alerting emergency and law enforcement personnel of unauthorized vehicle location and the like. A central reporting center coordinates the vehicle identification codes that are received via remote signals for reconciliation with a vehicle emergency tracker stored in the vehicle. Emergency procedures may be instigated as appropriate.

In U.S. Pat. No. 5,574,648, Pilley discloses an airport system for controlling and managing the surface and airborne movement of ground vehicles and aircraft within a defined and selected airport space. Using a 3-dimensional map having GNSS-based location points, this system provides a central monitor to track signals transmitted from the vehicles and aircraft, and to provide a series of individual layers for tracking each of the several vehicles and aircraft, and for isolating forbidden zones.

Gehlot, in U.S. Pat. No. 6,167,333, discloses a system for collecting motor vehicle-related information in real-time from a plurality of remote vehicle networked sensors and storing this information among various government entities. A processor contained in each vehicle receives data from the several mechanical and electrical sub-systems, microprocessors, and physical inputs. The system controller can prevent unauthorized personnel from starting any of the vehicles.

In U.S. Pat. No. 5,969,433, Maggiora teaches a theft preventing and deterring system for disabling an automotive vehicle when a predetermined event occurs. In particular, by using a plurality of sensors, the system monitors vehicle location via GPS and TELETRAC radio-location. The system may be programmed to automatically or manually intervene when such predetermined events occur.

In U.S. Pat. No. 6,198,992, Winslow discloses an apparatus which overrides a tractor guidance control system when an emergency condition occurs. A sensor is coupled to the steering or the clutch system to monitor tractor movements; when abnormal movements occur, an override signal is generated to release automatic steering control. The operator may then immediately manually take corrective action.

Graham et al., in U.S. Pat. No. 4,811,230, teach a system that enables a pilot to intervene in the preprogrammed flight of an airplane based upon signals received from Air Traffic Control. Intervention options include lateral and vertical direction, altitude, and speed.

Anthony et al. in U.S. Pat. No. 6,559,769, teach an early-warning security system for monitoring and tracking in real-time the activities and movements associated with prescribed personnel, personal property, mobile vehicles, and buildings. This system comprises a plurality of in situ local controllers having a microprocessor and a coordinated plurality of conspicuous and clandestine digital video cameras for continuously producing digital audio and visual signals, uplinking such signals via a suitable wireless telecommunications device to a satellite, general packet radio service, the Internet, intranet or extranet, and then downlinking these signals to a plurality of control centers for recording and analysis thereof. Remedial action is immediately taken when perturbations from normal behavior or activities are observed in the recorded audio and visual signals.

Thus, there have been many attempts to improve theft prevention and to deter theft of vehicles and airplanes using sensors and transmitters that signal when intervention in the operation of vehicle and airplane sub-systems should be triggered. Many of these vehicle intervention systems appear to be confined to the vehicle, per se. Some, on the other hand, use the GPS and the like to track vehicle movement and to transmit location data to a central control station. Airplane-related systems are designed to effect normal operations, but none seem to override the control of the airplane to the extent of negating local operation by an unauthorized terrorist pilot or even by an authorized pilot.

Accordingly, these limitations and disadvantages of the prior art are overcome with the present invention, and improved means and techniques are provided which prevent hijacking of commercial and public airplanes, ships, and motor vehicles.

### SUMMARY OF THE INVENTION

The present invention teaches a methodology for preventing hijacking of aircraft, ships, buses and other commercial surface motor vehicles, trains, and the like, by invoking an override means for taking control of such aircraft, ships, or other means of commercial and public transportation, when circumstances merit such drastic corrective action. According to the preferred embodiment of the present invention, if monitoring sensors indicate that exigent circumstances such as airplane hijacking is occurring, then action would be triggered from a central control to either disable the airplane, dump fuel, shutdown engines, or otherwise override control of the airplane. This action would frustrate the hijackers' purpose and could save lives and minimize losses.

It will become evident that the methodology of the present invention may be accommodated in applications not only using aircraft for travel, but also in applications using ships and the like for ocean travel, and trains, automobiles, buses and other commercial and public motor vehicles for surface travel.

These and other objects and features of the present invention will become apparent from the following detailed description, wherein reference is made to the figures in the accompanying drawings in which like numerals refer to like components.

### BRIEF DESCRIPTION OF THE DRAWINGS

FIG. 1 depicts a simplified schematic diagram of the preferred embodiment of the present invention for preventing hijacking of motor vehicles.

FIG. 2 depicts a flow chart of the hijack-preventive apparatus incorporated into an airplane according to the preferred embodiment of the present invention.

FIG. 3 depicts a flow chart of the apparatus incorporated into the plurality of control centers according to the preferred embodiment of the present invention.

FIG. 4 depicts a flow chart of the apparatus incorporated into the plurality of protected areas according to the preferred embodiment of the present invention.

FIG. 5 depicts a flow chart of the apparatus incorporated into the plurality of airplane input monitors and alarms according to the preferred embodiment of the present invention.

FIG. 6 depicts a logic diagram depicting the stepwise procedure of the preferred embodiment of the present invention that relates to airplane operations.

FIG. 7 depicts a logic diagram depicting the stepwise procedure of the preferred embodiment of the present invention that relates to flight control center operations and associated triggering events.

FIG. 8 depicts a logic diagram depicting the stepwise procedure of the preferred embodiment of the present invention that relates to protected areas for airplane flights and associated triggering events.

FIG. 9 depicts a flow chart of the hijack-preventive apparatus incorporated into a plurality of surface vehicles according to an alternative embodiment of the present invention.

FIG. 10 depicts a flow chart of the apparatus incorporated into the plurality of control centers according to the alternative embodiment of the present invention depicted in FIG. 9.

FIG. 11 depicts a flow chart of the apparatus incorporated into the plurality of surface vehicle input monitors and alarms according to an alternative embodiment of the present invention.

FIG. 12 depicts a logic diagram depicting the stepwise procedure of the alternative embodiment of the present invention that relates to operation of a plurality of surface vehicles.

FIG. 13 depicts a logic diagram depicting the stepwise procedure of the alternative embodiment of the present invention that relates to transportation control center operations and associated triggering events.

FIG. 14 depicts a logic diagram depicting the stepwise procedure of an alternative embodiment of the present invention that relates to protected areas for surface vehicle dispatch and transportation and associated triggering events.

### DETAILED DESCRIPTION

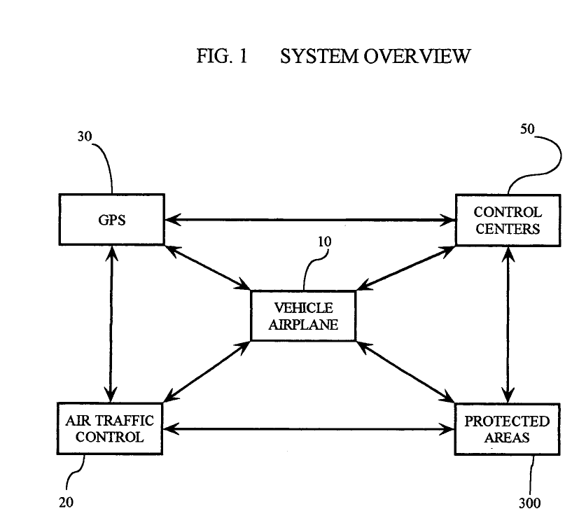

As will be hereinafter described in detail, the present invention comprises an anti-hijacking system applicable to motor vehicles illustrated by embodiments applicable to airplanes, automobiles and the like, ships, and trains. Now referring to FIG. 1, there is depicted a simplified schematic diagram of an overview of such an embodiment of the present invention 2 designed for preventing hijacking of vehicles.

The preferred embodiment corresponds to a system for preventing airplane anti-hijacking, and is depicted in the context of airplane 10 traversing airspace implicating plurality of protected areas 300, under the influence of plurality of flight control centers 50 and concomitant plurality of air traffic control centers 20. Each area of such plurality of protected areas is a geographical area that has been predetermined to be secure from any form of intrusion. In the context of the teachings of the present invention, an intrusion is contemplated to occur when an airplane or other motor vehicle deviates from its normal course of travel—outside of the plurality of protected areas—and is on a path that appears to imminently penetrate an area located therewithin.

As will be understood by those skilled in the art, this embodiment of the present invention contemplates exploiting GPS 30 or other real-time or near-real-time positioning means known in the art to monitor the progress and attitude of airplane 10 in real-time or near-real-time relative to its panoply of departure parameters, official flight path, arrival parameters, and any other relevant flight or travel parameters.

Referring now collectively to FIGS. 1-4, there is shown how various components of the preferred embodiment 2 interact with each other to accomplish the purposes contemplated by the present invention. Plurality of flight control centers 50 should preferably be located in a secure, limited-access location, such as a military base, and should preferably use dedicated secure electronic apparatus and the like, and, of course, be operated by properly trained personnel with sufficiently high security clearance. Secure locations and secure apparatus may be routinely insulated from penetration by unauthorized personnel and by unauthorized electronic transactions and the like, and from tampering by any personnel or electronic transactions. The preferred embodiment contemplates that this dedicated secure electronic apparatus and the like, and operational personnel are separate and distinct from air traffic control operations and concomitant personnel who operate conventional air traffic control system 20.

In a manner well known in the art, secure communications apparatus 60 on-board airplane 10 communicates and cooperatively interacts with each of corresponding apparatus located at plurality of control centers 50 and at plurality of protected areas 300. As will be appreciated by those skilled in the art, communications apparatus 60 receives input from a variety of monitoring sources including vehicle security systems and alarms 85, vehicle controls 75, and vehicle instrumentation 90. It will be appreciated that intelligence provided by vehicle instrumentation 90 includes information pertaining to speed, direction, fuel, throttle, etc. As will become evident, this input received by secure communications apparatus 60 located at airplane/vehicle 10 is relayed to plurality of control centers 50 for prompt observation and monitoring operations that will trigger an appropriate immediate response, when and if necessary.

According to the present invention, secure communications apparatus 60 controls and manages communications between plurality of protected areas 300 and airplane proximity transponder 95, which causes automatic activation of the automatic autopilot 80, when and if, aircraft 10 encroaches upon plurality of protected areas 300. Automatic autopilot 80 directs airplane 10 away from plurality of protected areas 300 and simultaneously alerts plurality of control centers 50 of this incident.

It will be understood that communications apparatus 60 directs communications between plurality of control centers 50 and airplane/vehicle local control cutoff switch 70, which alternatively permits or prevents the pilot from operating airplane 10 using conventional local flight controls 65. Similarly, secure communication means 60 directs communications between plurality of control centers 50 and vehicle controls 75, thereby triggering remote control of the airplane. It should be evident, of course, that use of the term “vehicle” in the context of the instant embodiment is synonymous with the term “airplane”; for convenience, the general term vehicle, which is intended to be applicable to all embodiments of the present invention, is used throughout. It will become clear that secure communication means 60 also enables remote activation of fuel release control 100. Depending upon the seriousness of circumstances related to the airplane's flight pattern and the condition and well-being of its crew and passengers, and the presence of hazardous cargo or the like, it may be deemed necessary by security personnel to either promptly release all fuel or excess fuel via remote activation of fuel release control 100.

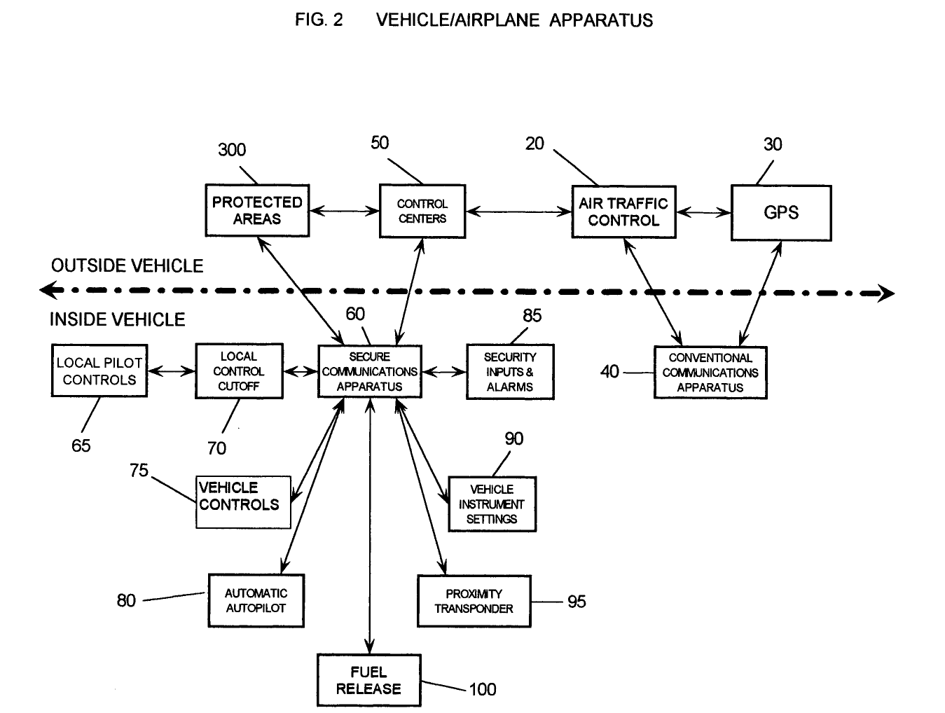

Secure communication means 60 also enables plurality of control centers 50 to remotely activate and deactivate automatic autopilot 80. According to the preferred embodiment, airplane vehicle 10, GPS 30 or other positioning system or the like, and air traffic control 20 also communicate via conventional communications means 40 to determine airplane location relative to the officially pre-approved flight plan or the like. Thus, FIG. 2 depicts a simplified flow chart of the preferred apparatus incorporated into an airplane. As is clearly depicted, airplane 10 remains in contact with air traffic control 20 via conventional communication means 40 typified by communications between a radio and a transponder, or the like.

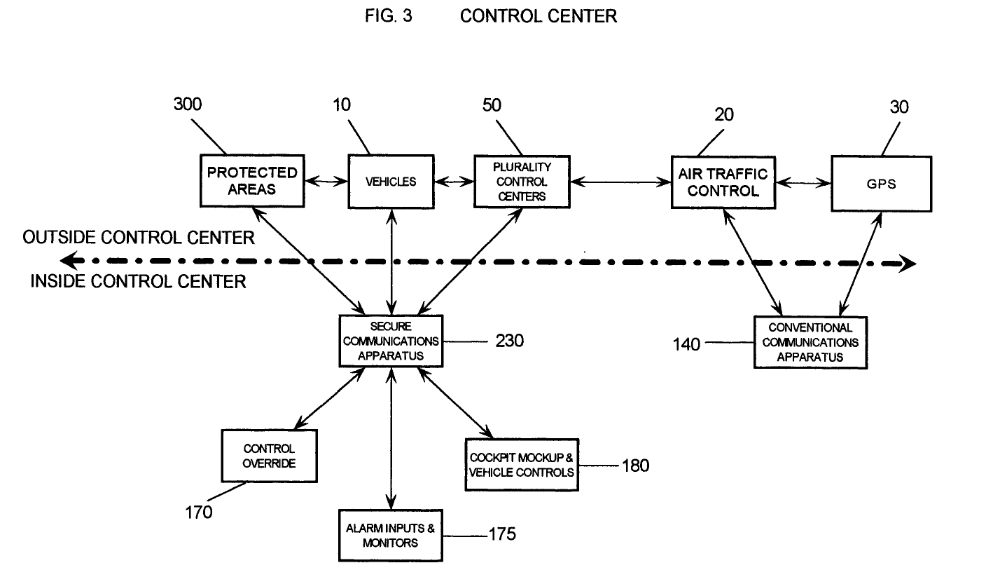

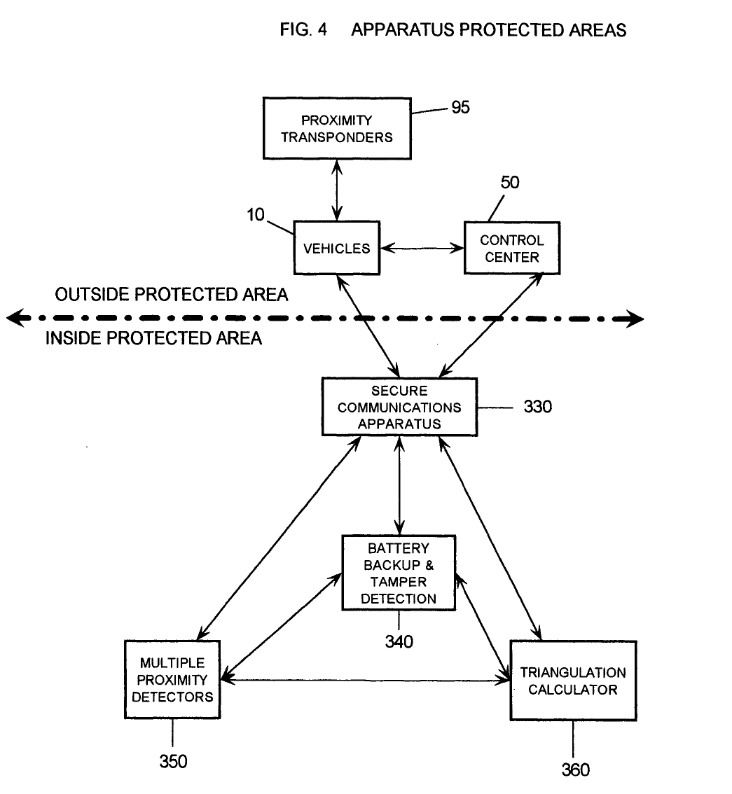

FIG. 3 depicts a simplified flow chart of the preferred apparatus incorporated into each of plurality of control centers 50 according to the present invention. For clarity, it should be understood that this flow chart includes a “centerline” to conveniently separate all of the components located inside plurality of control centers 50 from the components located outside thereof. Thus, all of the components disposed above this centerline—labeled “OUTSIDE CONTROL CENTER”—are located outside plurality of control centers 50. On the other hand, all of the components disposed below this centerline—labeled “INSIDE CONTROL CENTER”—are located within this plurality of control centers. This convention has also been incorporated into the other flow diagrams herein, namely, FIGS. 4-5 and 9-10.

Referring now to FIGS. 2 and 3, there is shown control center secure communication apparatus 230 interacting with similar secure communication apparatus 60 located at airplane 10, plurality of protected areas 300, and plurality of control centers 50. Secure communication means 230 relays the signals generated from this external apparatus to trained operators via control override switch 170, thereby permitting disabling local controls cutoff switch 70 of airplane 10. It will be appreciated that secure communication means 230 also transmits signals including alarm audio and video images to alarm and monitor apparatus 175. This alarm and monitor assembly enables operators to monitor conditions on any vehicle—selected either randomly or in response to an alarm or to a suspicious circumstance. Secure communication apparatus 230 also relays signals between airplane 10 and cockpit mock-up and vehicle controls 180. Cockpit mock-up and vehicle controls 180 receives all instrument data from the airplane, including video images indicating direction of travel, and a plurality of controls corresponding to local pilot controls 65. It should be evident that operation of this cockpit mock-up and vehicle controls is triggered when control override switch 170 is activated, thereby circumventing the affect of the local pilot controls 65 imposed upon vehicle controls 75.

Now referring specifically to FIG. 4, there is depicted a simplified flow chart of the apparatus typically incorporated into a plurality of protected areas according to the preferred embodiment of the present invention. Referring now to FIGS. 2 and 4, protected area secure communication means 30 interacts with corresponding secure communication means 60 located at airplane 10 and airplane proximity transponder 95. Upon ascertaining that airplane 10 has encroached upon at least one protected area of plurality of protected areas 300, transponder 95 sends a signal to airplane automatic autopilot 80 to activate a redirected, predetermined course that steers airplane 10 away from such plurality of protected areas. Communication means 330 simultaneously transmits a signal to plurality of control centers 50 when encroachment has occurred, permitting activation of remote control operations as contemplated by the present invention. It should be evident that communication means 330 also relays information to airplane 10 and to plurality of control centers 50, to constitute an alert that signals a current or imminent encroachment condition. Such timely information would alert control center personnel of such difficulty, prior to activation of automatic autopilot 80.

Communication means 330 obtains input from plurality of proximity sensors 350 and associated triangulation device 360. Triangulation device 360 compares signals from plurality of proximity sensors 350 to determine the location of vehicle 10, within the dimensionality of plurality of protected areas 300. In a manner known in the art, secure communication means 330 is preferably configured with battery backup 340, and preferably with redundant transmitters or other communication devices to assure uninterrupted operations.

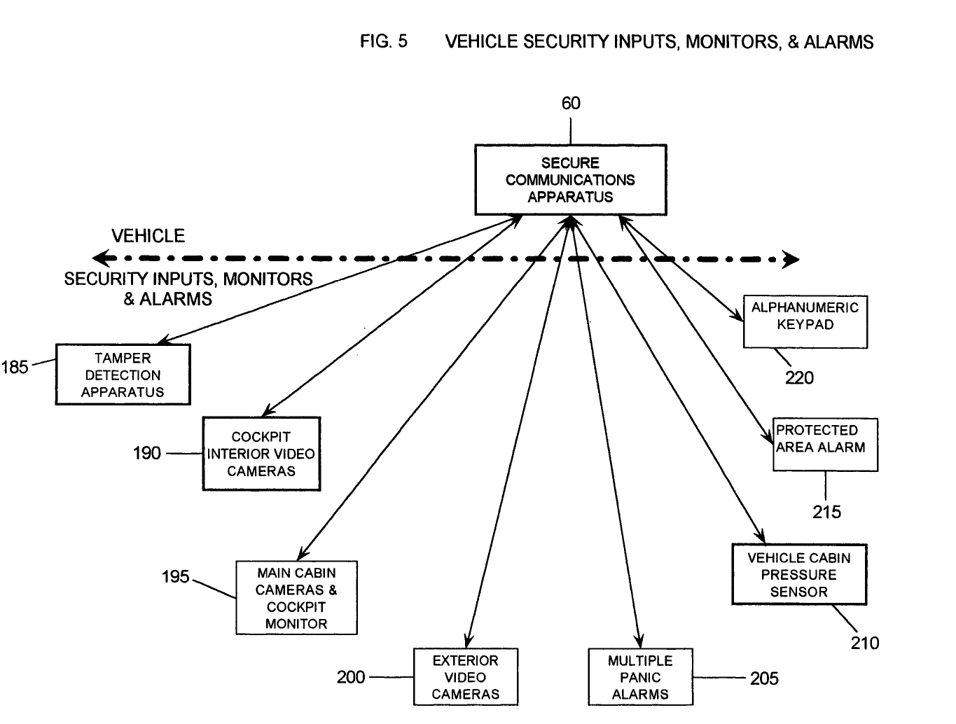

Referring now to FIG. 5, there is depicted a flow chart of the apparatus incorporated into the plurality of airplane input monitors and plurality of alarms according to the preferred embodiment of the present invention. Referring to FIGS. 1-5, there is shown representative inputs and alarms monitored by control center alarm and monitor means 175. As will be understood by those skilled in the art, these may include plurality of cockpit interior cameras 190 which enable control center operators to monitor cockpit activities. Such monitoring may include loss of tracking signal or the like. Similarly, plurality of main cabin video cameras 195 enable the control center operators and local pilots to monitor main cabin activities.

It should be clear that plurality of exterior video cameras 200 depict the crucial direction-of-travel view for assisting control center operators to remotely orchestrate safe airplane operation and, if necessary, immediate safe landing of the airplane. Multiple panic alarms 205, located throughput the airplane allow passengers or crew to alert both the pilot and control centers regarding disturbances in the main cabin or the like. In addition, cabin pressure alarm 210 may alert control center personnel of sudden changes in cabin pressure that might undermine or even disable pilot-behavior. Similarly, protected area alarms 215 alert the control center personnel of warnings of impending protected area encroachment, or of actual encroachment thereof; according to the present invention, simultaneously, such alarm condition signals activation of the crucial automatic autopilot function.

Under the preferred embodiment, tamper detection means 185 should preferably be installed to detect unauthorized access to the on-board circuitry and the like. It should be evident that this may be implemented via a pressure switch that is activated when an access cover is removed or any of the several alternative means known in the art. It will be appreciated by those skilled in the art that alphanumeric keypad 220 may be used to input a security password to authenticate the pilot's identity prior to commencement of the flight. In addition, access to the on-board circuitry and the like could be accessible only from the exterior of the aircraft, thus making tampering impossible while in flight.

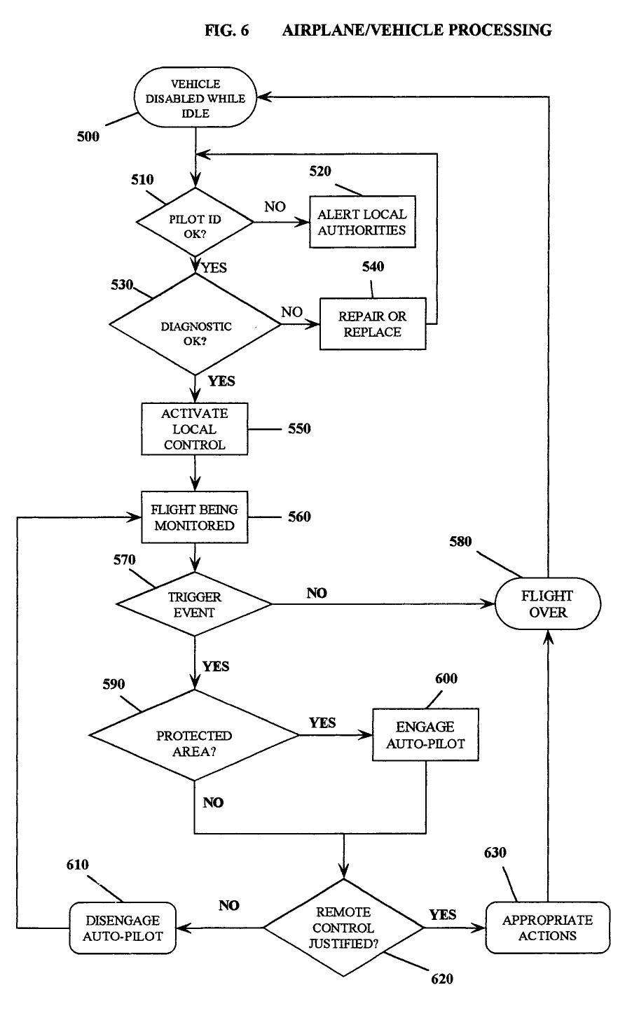

FIG. 6 depicts a logic diagram depicting the stepwise airplane operations procedure of the preferred embodiment. First, in the step represented by numeral 500, airplane 10 is parked in its designated airport gate, disabled by local cutoff switch 70. It will be evident that airplane 10 is situated in its designated gate after the completion of an authorized flight, and prior to receiving authorization to leave the gate to commence a subsequently departing flight. Next, in the step depicted by numeral 510, the pilot's identity is verified using plurality of cockpit video cameras 190 and security keypad 220. If unauthorized attempts to activate the airplane persist, then plurality of control centers 50 will sustain the airplane's disabled state and simultaneously will notify local authorities to apprehend what appears to be an intruder (in step depicted by numeral 520).

In the step represented by numeral 530, an authorized pilot will verify, in conjunction with personnel at plurality of control centers 50, that all security devices and controls 85 are in proper working order. If not, malfunctioning devices and controls should preferably be replaced or repaired, and the pilot ID verified (in the step depicted by numeral 510). If all security devices and controls 85 are in proper order, plurality of control centers 50 will activate local control via deactivation of local control switch 70. Then, the flight will commence, and will continue to be monitored by the plurality of control centers 50 as shown in the step designated by numeral 560. If a triggering event in the step depicted by numeral 570 fails to occur, then the flight will conclude in due course (step designated by numeral 580), and the airplane is returned to the idle condition in the step represented by numeral 500. On the other hand, if a triggering event occurs as shown in the step represented by numeral 570, if it is determined to be occurring via a protected area alert (step designated by numeral 590), the automatic autopilot 80 will automatically be engaged in the step designated by numeral 600.

It should be evident that such engagement of the automatic autopilot, when the plane has encroached upon a protected area, will preferably expeditiously direct the plane out thereof. However, if the plane is not in a protected area in the step designated by numeral 590, then, in the step designated by numeral 620, plurality of control centers 50 should preferably review cumulated security data to determine if invoking the remote control aspect of the present invention is merited. If invoking the remote control aspect is not merited, then, if applicable, in the step represented by numeral 610, the autopilot will be disengaged and flight monitoring resumed (in step designated by numeral 560). If, on the other hand, invoking the remote control aspect of the present invention is merited, plurality of control centers 50 will take appropriate actions to safely control and land the airplane (in step designated by numeral 580) in the step represented by numeral 630.

Table I enumerates a panoply of triggering events for which embodiments of the present invention are designed to cause immediate responsive behavior to avert or minimize loss of life and destruction to an airplane and other vehicles and property.

TABLE I

Triggering Event-Airplane
Cabin Decompression
Panic Alarm
Protected Area Alarm
Off-Course Alarm
Airspeed
Rate of Descent or Ascent
Attitude
Visual Observations
Loss Of Video Signals
Tampering

As will be readily understood by those skilled in the art, cabin decompression is a triggering event that may indicate that the pilot is unable to control the flight due to lack of oxygen. Obviously, loss of cabin pressure is a serious situation that merits immediate attention. As hereinbefore described, the panic alarm may be activated by either a passenger or a crew member, or perhaps both. Assuming that a false alarm has not occurred, the cause of the alarming condition must be immediately ascertained. The triggering of a protected area alarm indicates that the flight has encroached, or is in imminent danger of encroaching, a protected area. Promptly avoiding or immediately reversing such entry is obviously the order of the day. Of course, triggering a tamper-detection alarm indicates that an intruder is afoot and is threatening the integrity of the anti-hijacking system taught by the present invention. The off-course alarm, attitude alarm, and other alarms would also indicate the incapacity of the pilot from a sudden illness, drugs or alcohol, or indicate actions by a renegade pilot.

It should be clear to those skilled in the art that triggering of an off-course alarm, which may obtain from a GPS or other positioning system or from air traffic control, is indicative of the airplane deviating from its flight plan; instantaneous remedial action should preferably be instigated. An airspeed alarm would indicate a pilot's loss of control wherein the airplane is experiencing an abrupt dive or a stall, or that the airplane is executing an emergency maneuver. A trigger attributable to a rate of ascent/descent alarm would indicate a pilot's loss of control perhaps because the airplane is in a dive or a stall or is executing an emergency maneuver. It should be apparent that an attitude alarm would indicate the pilot's loss of control due to a radical turn or an emergency maneuver.

Visual observations from any of the plurality of interior video cameras would constitute a trigger of responsive action that must be taken forthwith to address a disturbance in the main cabin or cockpit. Similarly, visual observations from this plurality of exterior video cameras would indicate that there is an obstacle in the airplane's flight-path and that immediate remedial action must be taken. Loss of interior video would indicate that terrorist hijackers are obscuring or disabling the plurality of cameras to conceal their dastardly actions. Another triggering event would be loss of signals that would indicate a malfunction or tampering with the airplane's functions. According to the present invention, such loss of signals would trigger immediate recall of the airplane by flight control and any other appropriate actions such as a military escort to a nearby military base or airport.

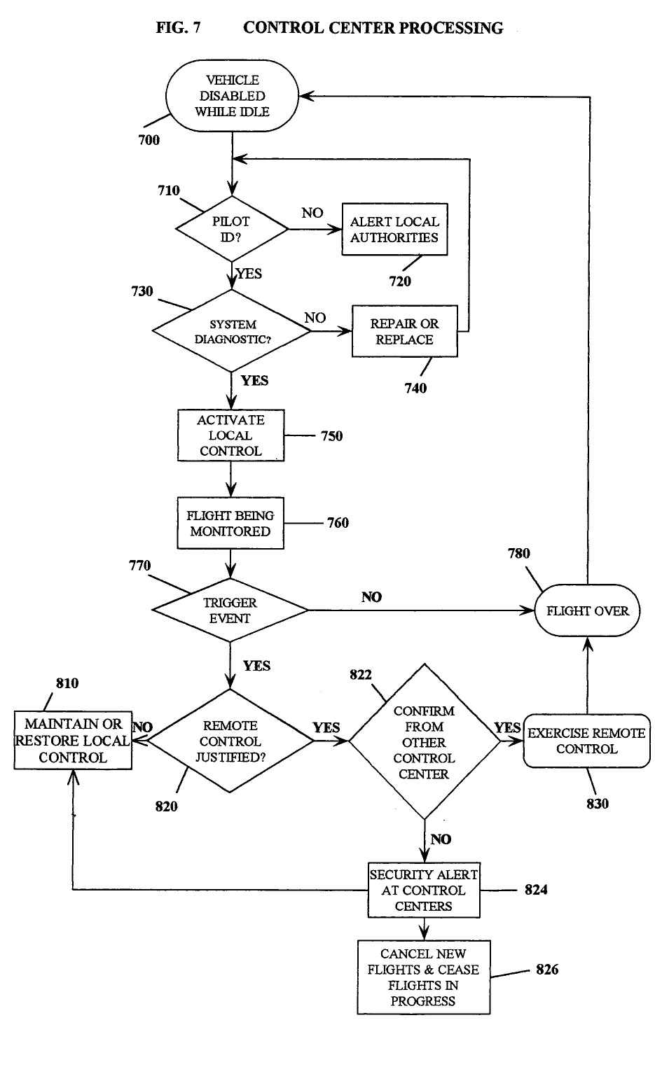

Referring now to FIG. 7, there is depicted a logic diagram depicting the stepwise procedure of the preferred embodiment that relates to control center operations and triggering events. First, in the step represented by numeral 700, airplane 10 is parked in its designated airport gate, disabled by local cutoff switch 70. It will be evident that this airplane is situated in its designated gate after the completion of an authorized flight, and prior to receiving authorization to leave the gate to commence a subsequently departing flight. Next, in the step depicted by numeral 710, the pilot's identity is verified using plurality of cockpit video cameras 190 and security keypad 220. If unauthorized attempts to activate the airplane persist, then plurality of control centers 50 will sustain the airplane's disabled state and simultaneously will notify local authorities to apprehend what appears to be an intruder (in step depicted by numeral 720).

In the step represented by numeral 730, an authorized pilot will verify, in conjunction with personnel at plurality of control centers 50, that all system diagnostics are satisfactory, thereby indicating that security devices and controls 85 are in proper working order. If not, malfunctioning devices and controls should preferably be replaced or repaired (in the step depicted by numeral 740). If all security devices and controls 85 are in proper order, then, in the step represented by numeral 750, plurality of control centers 50 will activate local control via deactivation of local control switch 70. Then, the flight will commence, and will continue to be monitored by the control center 50 as shown in the step designated by numeral 760. If triggering events, in the step depicted by numeral 770, fail to occur, then the flight would conclude in due course (step designated by numeral 780), and the airplane would be returned to the idle condition in the step represented by numeral 700. On the other hand, if a triggering event occurs, as shown in the step represented by numeral 820, the control center would preferably review cumulated security data to determine if invoking the remote control aspect of the present invention is justified. If invoking the remote control aspect is not merited, then, in the step represented by numeral 810, local control of the airplane would be sustained or restored, and then flight-monitoring would be resumed (in step designated by numeral 760). If, on the other hand, invoking the remote control aspect of the present invention is merited, the plurality of control centers would preferably reconcile the collective monitoring and security data in step designated by numeral 822.

After this reconciliation of cumulative security data, in the step represented by numeral 830, it would be further ascertained whether invoking the remote control aspect of the present invention is merited. If so, then control center personnel would take appropriate actions to safely control and land the airplane, thereby terminating the flight, in the step represented by numeral 780. If not, then there would be a security alert at all control centers to ascertain the source of the triggering event (in the step designated by numeral 824). If the security breach may be effectively remedied, in the step designated by numeral 824, local control may be sustained or restored in the step designated by numeral 810, and flight-monitoring would continue (in step designated by numeral 760). If the security breach persists and is sufficiently hazardous to public safety or the like, then, in the step designated by numeral 826, all new flights would be canceled and all flights in progress terminated to avoid or minimize serious personal injury and damage to property.

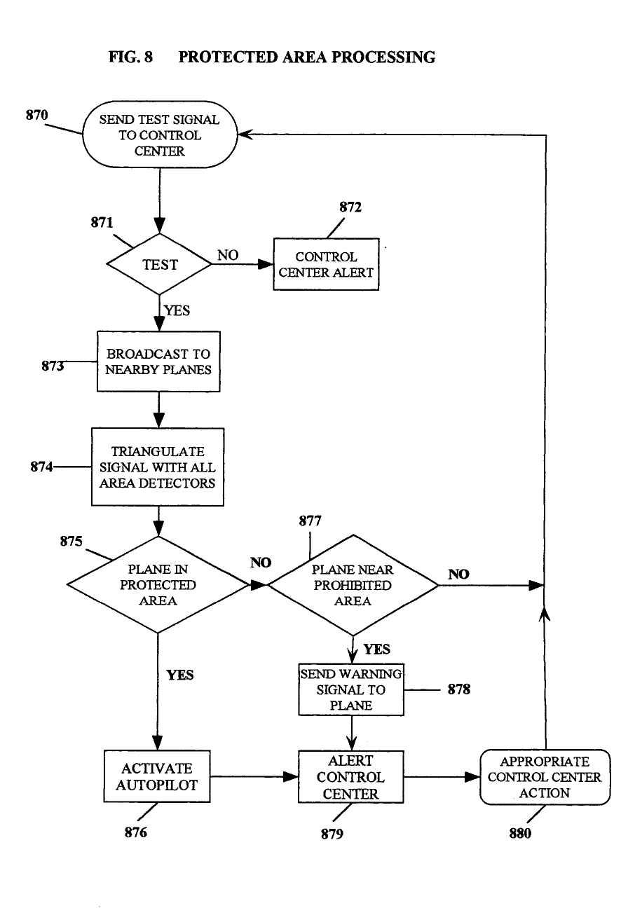

FIG. 8 depicts a logic diagram depicting the stepwise procedure of the preferred embodiment that relates to the contemplated operation of protected areas and concomitant triggering events. In the step represented by numeral 870, each of secure communication apparatus 60 (FIG. 2) and secure communication apparatus 230 (FIG. 3) and secure communication apparatus 330 (FIG. 4) periodically sends a test signal to plurality of control centers 50 and then runs a self-test in the subsequent step (represented by numeral 871). If this self-testing indicates that there are communication problems or other problems, in the step designated by numeral 872, plurality of control centers 50 would observe the malfunction or loss of signal condition, and then would immediately dispatch personnel to repair or replace the malfunctioning device, and, in the interim, would more closely monitor, divert, or ground flights that might enter affected protected area 300. On the other hand, if the self-test and communication checks are fine, then plurality of protected areas 300 would broadcast indicative signals to potential nearby planes and other vehicles, in the step designated by numeral 873. According to the present invention, upon interacting with proximity transponder 95 disposed upon a nearby airplane or other vehicle, triangulation calculator 360 would determine the airplane/vehicle position in the step represented by numeral 874.

It will be appreciated that, if airplane 10 is determined to be positioned within the protected area in the step designated by numeral 875, then automatic autopilot 80 would be activated in the subsequent step (represented by numeral 876) to direct the airplane safely away from plurality of protected areas 300. In the step designated by numeral 877, if airplane 10 is ascertained to be nearby, albeit not yet within at least one of plurality of protected areas 300, a warning signal would preferably be sent to the airplane in the step represented by numeral 878. If automatic autopilot 80 were activated in the step designated by numeral 876, or if a warning signal were sent to airplane 10 in the step designated by numeral 878, the present invention would send an alert via secure communication apparatus 230 to plurality of control centers 50 in a subsequent step (designated by numeral 879). It should be evident to those skilled in the art that personnel situated at plurality of control centers 50 would assess the situation and take appropriate and prompt action in the step designated by numeral 880. It will, of course, be clear, that protected area 300 would continuously repeat the entire testing, broadcasting and triangulation process in the step designated by numeral 870.

Other embodiments of the present invention have been configured to accommodate other types of vehicles such as ocean-faring ship and other vessels, trains, automobiles, trucks, and buses. It should be evident to those skilled in the art that the present invention is designed to provide an override protocol that remotely monitors the activities of such vehicles that continuously occur over a prescribed path or track. Located in secure locations, a plurality of control centers receive data that describes the progress of such vehicles relative to the prescribed travel plan and enables any deviations thereof to be flagged for immediate corrective action initiated by a remote control infrastructure. This corrective action essentially overrides local control of the operation of the vehicle so that no further deviation from the prescribed plan may be realized by rogues or terrorists, thereby preventing or mitigating loss of life and damage to property. It should also be evident that embodiments of the present invention provide an expedient means for effectuating remote rescue of a vehicle that has inadvertently deviated from its prescribed travel route due to instrument or apparatus malfunction or whose operators have become involuntarily disabled due to medical emergency or hijacking or the like.

It will be clear to those skilled in the art that embodiments of the present invention may be adapted to prevent hijacking of vehicles other than airplanes, such as surface vehicles including seafaring vessels. It will also be readily understood that such embodiments may be adapted to accommodate surface vehicles such as automobiles, trains, trucks, and buses. It will be appreciated that, while these particular alternative embodiments are applicable to surface vehicles, such embodiments are especially applicable to commercial shipping which is intertwined with a plurality of surface vehicles that have been designated to transport a plurality of goods as a shipment. Furthermore, it will be understood that these alternative embodiments would be particularly applicable to shipments involving transport of sensitive materials such as radioactive products and waste.

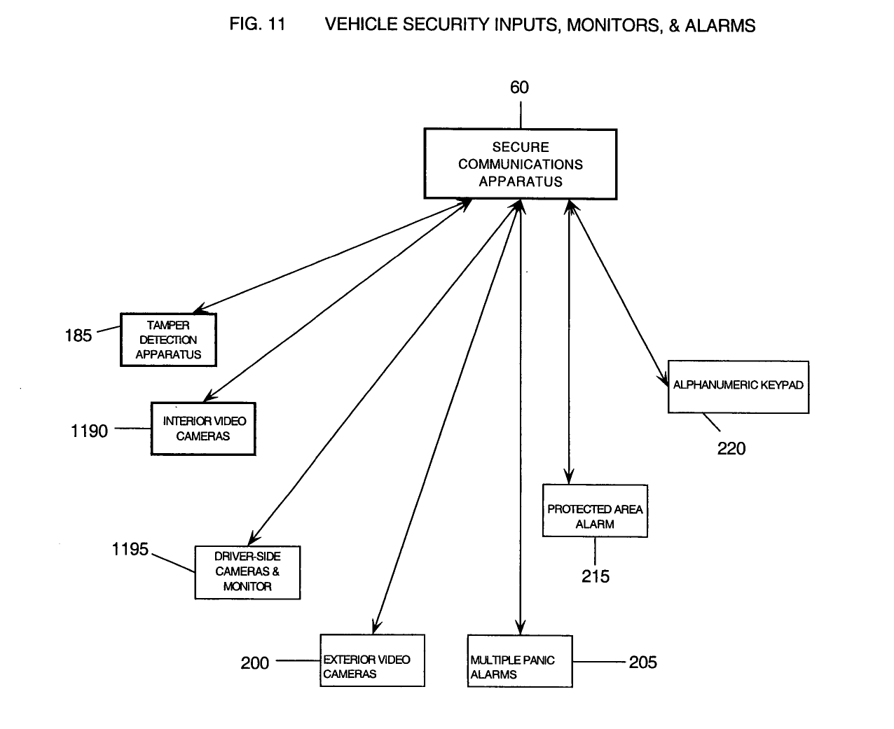

Anti-hijacking embodiments of the present invention may be envisioned in the context of implementations that affect a plurality of surface vehicles that operate under the influence of a plurality of control centers as contemplated hereunder. Similar to the hereinbefore described airplane embodiment depicted in FIGS. 1-3, 4, and 5-8, a typical alternative embodiment is depicted in FIGS. 4, and 9-14; it uses a global positioning system (“GPS”) or other real-time or near-real-time positioning means known in the art to monitor the progress and attitude of a plurality of surface vehicles. Incorporated into this monitoring and analysis are the surface vehicles' panoply of departure parameters, pre-approved course plan, arrival parameters, and any other relevant transportation and shipping parameters.

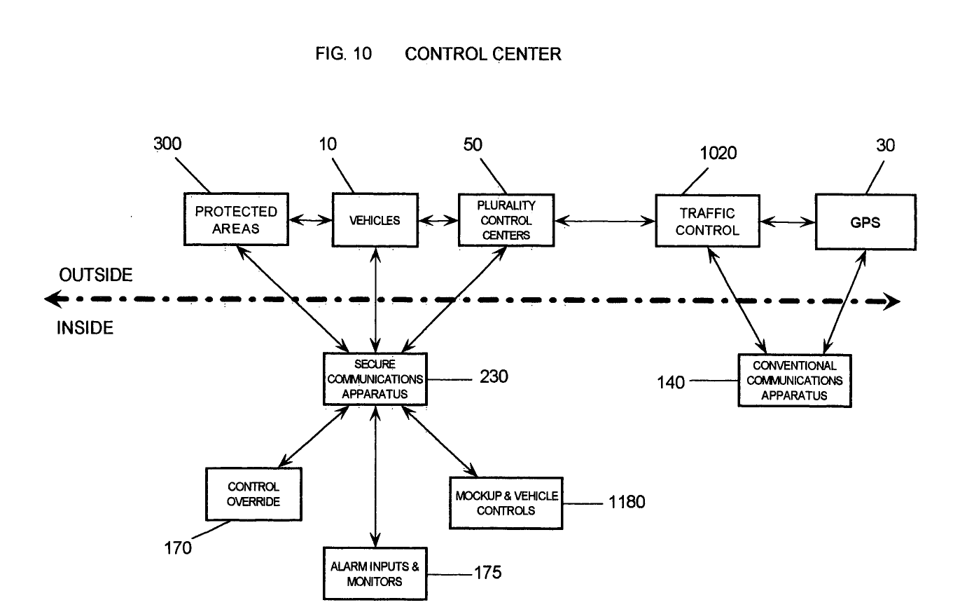

The present invention contemplates control center facilities being preferably clandestinely situated within the secure confines of a military base or the like. Ergo, referring specifically to FIG. 10, plurality of control centers 50 should preferably be located in secure, limited-access locations, and should preferably use dedicated secure communications apparatus 230 and the like, and, of course, should preferably be operated by properly trained personnel with sufficiently high security clearance. As is well-known in the art, plurality of secure locations 300 and secure communications apparatus 230 are typically insulated from penetration by unauthorized personnel and by unauthorized electronic transactions and the like, and from tampering by any unauthorized personnel or unauthorized electronic transactions.

Suitable secure communications apparatus 230 receives input from a variety of monitoring sources including surface vehicle security systems and alarms 175, surface vehicle controls 1180, and related surface vehicle instrumentation 85 including tamper detection apparatus 185, plurality of internal video cameras 1195 disposed in the driver's seat compartment, plurality of internal video cameras 1190 disposed in the passengers' compartment, plurality of exterior video cameras 200, plurality of panic alarms 205 disposed throughout the vehicle, and alphanumeric keypad 220. It will be appreciated that intelligence provided by this panoply of vehicle instrumentation includes information pertaining to speed, direction, fuel, throttle, etc. As will become evident, this input received in situ by communications apparatus 60 disposed in plurality of surface vehicles 10 is relayed to plurality of control centers 50 for observation and monitoring operations that would trigger an appropriate immediate response affecting the uninterrupted continuation of normal operation of plurality of surface vehicles 10, when and if necessary.

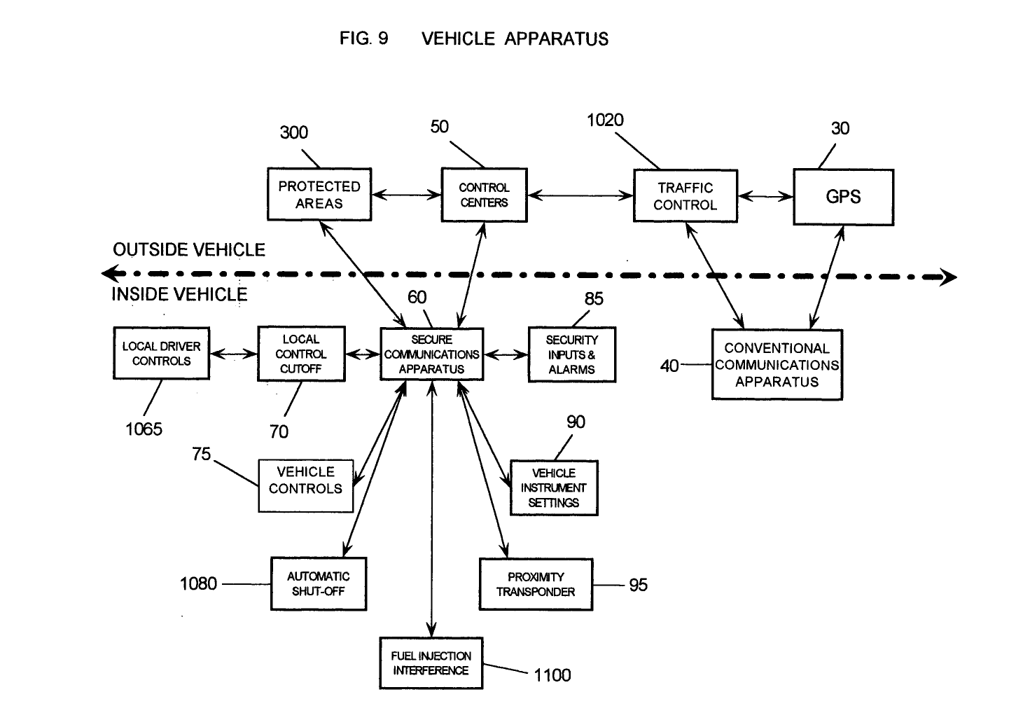

Referring now to FIGS. 9 and 10, it will be understood that exchanges between vehicle communications apparatus 60 and control center communications apparatus 230 directs ongoing communications between plurality of control centers 50 and surface vehicle local control override, i.e., cutoff means, 70, which alternatively permits or prevents drivers from operating such surface vehicles using conventional local controls 140. Similarly, this exchange of secure communications directs communications between plurality of control centers 50 and plurality of surface vehicle controls 140, thereby triggering remote control thereof. It should be clear that this secure communication means also enables remote activation of fuel cutoff control 1100.

Depending upon the seriousness of circumstances related to the surface vehicle's trip and the condition and well-being of its operator and passengers, and the presence of hazardous cargo or the like, it may be deemed necessary by security personnel to either effectuate all fuel being promptly being rendered inaccessible to the engine or otherwise interfering with the normal behavior of the fuel injection system or the like via remote activation of a fuel cutoff valve or the like. In situations involving movement of vessels, such fuel turnoff procedures would implicate preventing the feeding of fuel to the on-board engines or even dumping fuel into the ocean or the like. While fuel-dumping obviously would constitute an insult to the integrity of the ocean and other environments, it may be unavoidable in order to seek to stymie the life-threatening modus operandi of terrorists and the like. Similarly, fuel-dumping into the environment may be an unavoidable necessity to combat life-threatening behavior on trains, buses, and other means of surface transportation.

Secure communication means 60 disposed in vehicle 10 also enables plurality of control centers 50 to remotely activate and deactivate the involvement of emergency security and law enforcement personnel which makes use of a GPS or similar positioning system, and a conventional vehicle dispatching means. It is contemplated that these personnel will communicate via suitable high-priority control center secure communications means 230 to determine surface vehicle location relative to a pre-approved travel and/or shipment plan. It is further contemplated that surface vehicles would preferably sustain contact with a dispatcher or the like via suitable secure communication means 60 which is commonly implemented by communications effectuated between a radio and proximity transponder 95.

As hereinbefore described, each of the plurality of control centers 50 uses secure communication apparatus 230 that interacts with similar secure communication apparatus 60 located in situ at plurality of surface vehicles 10. Secure communication means 60 relays the signals generated from this external apparatus to trained operators via control override switch 170, thereby permitting disabling a local surface vehicle's controls cutoff switch 70. It will be appreciated that secure communication means 60 also provides signals, alarms, and videos to alarm and monitor apparatus 175. This alarm and monitor assembly 175 enables operators to monitor conditions on any surface vehicle—selected either randomly or in response to an alarm or to suspicious circumstances.

Such secure communication apparatus also relays signals between a surface vehicle and a vehicle mock-up and vehicle controls 1180. The surface vehicle mock-up and controls 1180 receives all instrument data 90 from the surface vehicle, including video images indicating direction of travel, and a plurality of controls corresponding to the local operator/driver's controls 1065. It should be evident that operation of such vehicle mock-up and vehicle controls 1180 are triggered when control override means 170 is activated, thereby circumventing the affect of the local operator/driver's controls 1065 disposed on the surface vehicle's controls 75.

As elucidated hereinbefore, with reference to FIGS. 9-11, embodiments of the present invention include plurality of vehicle/vessel input monitors and alarms 85 that are preferably monitored by control center alarm and monitor apparatus 175. These may include plurality of interior cameras 1190 which enable control center operators to monitor activities occurring within a plurality of vehicles and vessels. Such monitoring may include loss of tracking signal or the like. Similarly, plurality of additional video cameras 200 enable the control center operators and local operators to monitor passenger, trunk, and cargo activities. It should be clear that plurality of exterior video cameras 200 depict the crucial direction-of-travel view for assisting control center operators to remotely orchestrate safe vehicle and vessel operation and, if necessary, stop a vehicle or vessel, or seek to guide it to a known and secure location. Plurality of panic alarms 205 that are located throughout the vehicles and vessels allow the operator or passengers to alert both the operator and control centers regarding on-board disturbances; the passengers may also use preferably a clandestine alarm to alert the operator about such local disturbance.

It should, of course, be appreciated that tamper detection means 185 should preferably be installed in situ at vehicle 10 to detect unauthorized access to on-board control circuitry 75 or the like. It should be evident that this may be implemented via a pressure switch that is activated when an access cover is removed or any of several means known in the art. It will be appreciated by those skilled in the art that an alphanumeric keypad 220 or the like may be used to input a security password to authenticate the operator's identity prior to commencement of the shipment. In addition, access to the on-board circuitry and the like could be accessible only from the exterior of the surface vehicles and vessels, preferably the underside thereof, thus making tampering impossible while travel of a surface vehicle fleet has commenced.

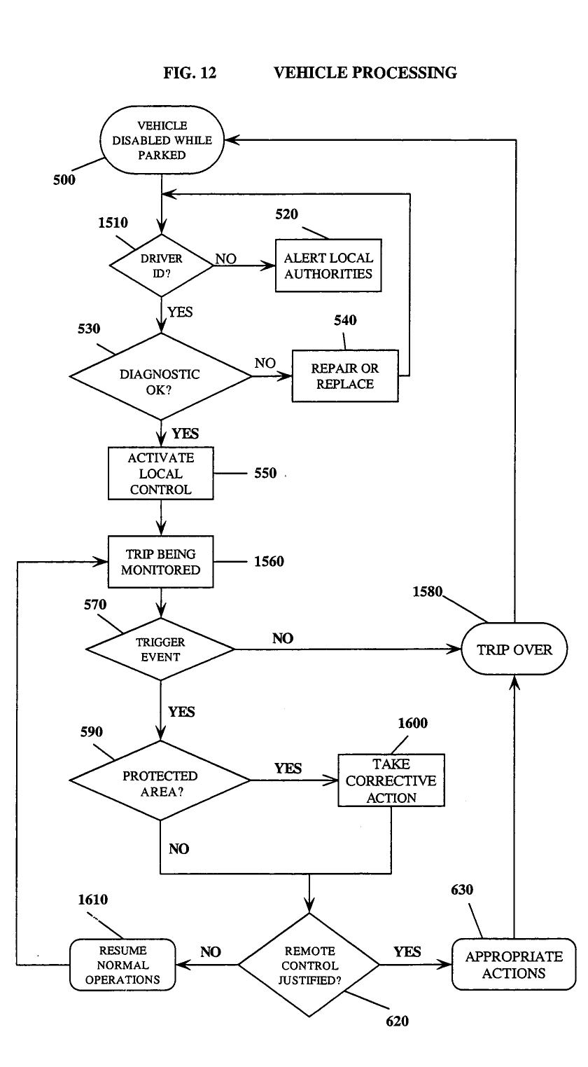

As shown in FIG. 12, the hereinbefore described stepwise procedure has been adapted in the instant embodiment to accommodate surface vehicle operations. First, in step 500, a surface vehicle is parked in its designated location, disabled by its local cutoff switch. It will be evident that this vehicle is parked in its designated spot after the completion of an authorized travel plan and/or shipment, and prior to receiving authorization to commence a subsequent travel plan and/or shipment. Next, in step 1510, the operator's identity is verified using a plurality of cockpit video cameras and a security keypad. If unauthorized attempts to activate the vehicle persist, then a plurality of control centers would sustain the vehicle's disabled state and simultaneously would notify local authorities (step 520) to apprehend what appears to be an intruder. An unauthorized operator would preferably be detained in the vehicle by remotely activated door locks or the like. Similarly, for a vehicle manifest as an ocean-faring vessel, such unauthorized operator would preferably be detained in the captain's navigational venue, quarters, or the like by remotely activating door locks thereto. Of course, local authorities would immediately dispatch a suitable enforcement vessel operated by the Coast Guard or the like.

Next, as hereinbefore described, in step 530, an authorized operator verifies, in conjunction with personnel at a plurality of control centers, that all security devices and controls are in proper working order. If not, in step 540, malfunctioning devices and controls should preferably be replaced or repaired, and the operator's ID verified. If all security devices and controls are in proper order, the plurality of control centers would activate local control by deactivating the local control switches, in step 550. Then, the shipment would commence, and continue to be monitored, in step 1560, by plurality of control centers 50 contemplated hereunder. If a triggering event fails to occur, then the shipment would conclude in due course (step 1580), and the surface vehicle returned to its idle condition (step 500).

The plurality of control centers should preferably review accumulated security data to determine if invoking the remote control aspect of the present invention is warranted, in step 620. If invoking the remote control aspect of the present invention is, indeed, merited, in step 630, then the plurality of control centers would take appropriate action to safely control and stop the vehicle or vessel.

Table II enumerates a panoply of triggering events that embodiments of the present invention are designed to cause immediate responsive behavior to avert or minimize loss of life and destruction to a plurality of surface vehicles and concomitant property.

TABLE II

Triggering Event-Surface Vehicle
Panic Alarm
Acceleration Alarm
Off-Course Alarm
Speed
Visual Observations
Loss Of Video Signals
Tampering

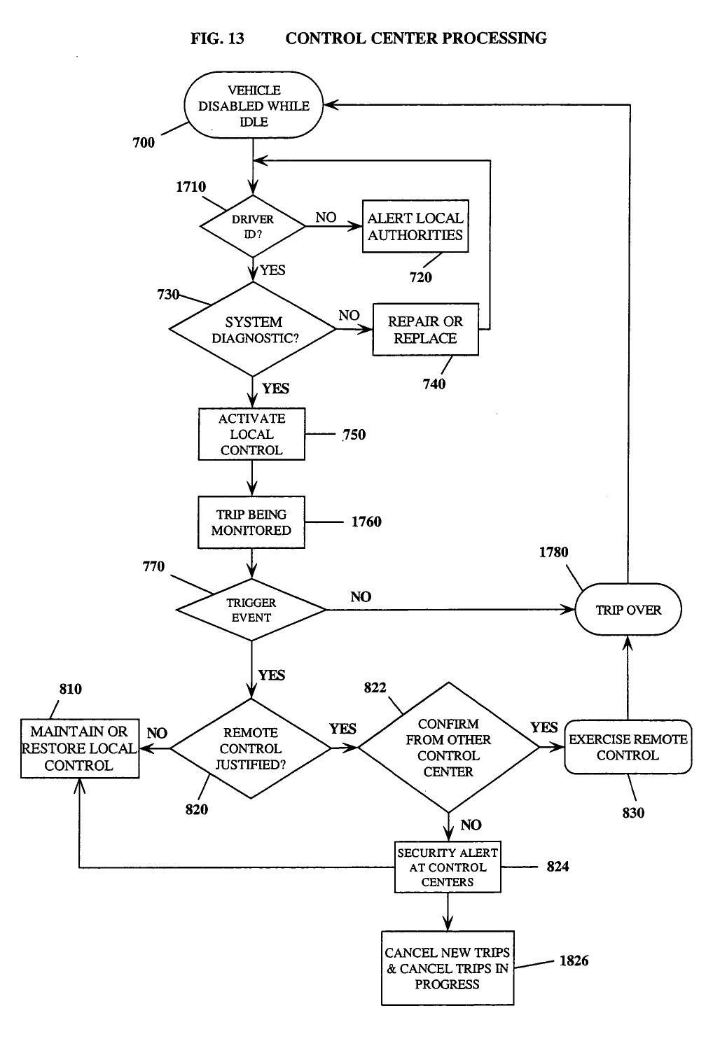

FIG. 13 depicts a logic diagram depicting the stepwise procedure of this alternative embodiment of the present invention that relates to transportation control center operations and associated triggering events. It will be understood that the panic alarm may be activated by either a driver/operator, passenger or other transportation and/or shipping personnel. System malfunctions such as false alarm conditions would be determined in step 730 by generating an appropriate system diagnostic message. Then, repair or replacement of defective components would occur in step 740 or local control would be activated in step 750. Assuming that a false alarm has not occurred, the cause of any alarm-condition must be immediately ascertained while the trip is being monitored in step 1760. Of course, triggering a tamper-detection alarm would indicate that an intruder is afoot and is threatening the integrity of the anti-hijacking system taught by the present invention. In step 1710, such intruder would fail to satisfy the driver identification in step 1710 so that local authorities would be notified of this transgression in step 720. A plurality of alarms—corresponding to an off-course alarm, attitude alarm, and other alarms—would also indicate the incapacity of the driver/operator from a sudden illness, drugs or alcohol, or indicate actions by a renegade operator/driver.

It should be clear to those skilled in the art that triggering of an off-course alarm, which may obtain from a GPS or other positioning system or from a dispatching center, is indicative of the surface vehicle deviating from its scheduled course of travel; instantaneous remedial action should preferably be instigated. An acceleration alarm could indicate an emergency maneuver or indicate the operator/driver's loss of control due to rough road or rough sea, an obstacle or damage to the vehicle or vessel, as appropriate.

Visual observations from any of the plurality of interior video cameras would constitute a trigger of a responsive action that must be taken forthwith to address a disturbance in the vehicle or vessel. Similarly, visual observations from the plurality of exterior video cameras would indicate that there is an obstacle in the surface vehicle's path and that immediate remedial action must be taken. Loss of interior video would indicate that a terrorist hijacker is obscuring or disabling the plurality of cameras to conceal their dastardly actions. Another triggering event would be loss of signal that would indicate a malfunction or tampering with vehicle or vessel functions. As depicted in step 1780, such loss of signal would trigger immediate stopping or recall of the vehicle or vessel by remote control and any other appropriate actions such as a military or police escort.

This embodiment of the present invention follows similar logic and procedures as has been hereinbefore described in detail respecting control center operations and triggering events. Thus, each surface vehicle is contemplated as being situated or parked in its designated initial location or spot (step 700), disabled by an appropriate local cutoff switch. It will be evident that the surface vehicle is situated in its designated spot prior to receiving authorization to leave to commence a scheduled trip perhaps with an associated shipment of goods. Next, in step 1710, the operator/driver's identity is verified using a plurality of interior video cameras and an associated security keypad. If unauthorized attempts to activate the surface vehicle persist, then a plurality of control centers will sustain its disabled state and simultaneously would notify local authorities, in step 720, to apprehend what appears to be an intruder, and would remotely activate door locks or other known instrumentality to detain the intruder on such surface vehicle on land or sea, as represented in the steps initiated in step 820. That is, if such remote control is merited (step 820), then confirmation from other control centers would be sought (step 822) and the trip or shipment would be terminated in steps 830 and 1780. If confirmation from other control centers were not obtained, then, in steps 824 and 1826, a security alert would preferably be generated at such other control centers and trips/shipments in progress would be cancelled, with any new trips/shipments being cancelled. Obviously, if remote control were deemed to be unnecessary, then in step 810, local control of surface vehicle operation would be sustained or restored.

It will also be understood that embodiments of the present invention may be implemented to accommodate railroad travel—similar to embodiments suitable for air and surface travel. Thus, such anti-hijacking embodiments may be visualized in the context of a plurality of trains traversing a countryside and the like, under the influence of a plurality of control centers as hereinbefore described. The present invention contemplates such an embodiment using a global positioning system or another real-time or near-real-time positioning system relative to a plurality of departure and arrival parameters, authorized trip route, and any other relevant train travel parameters.

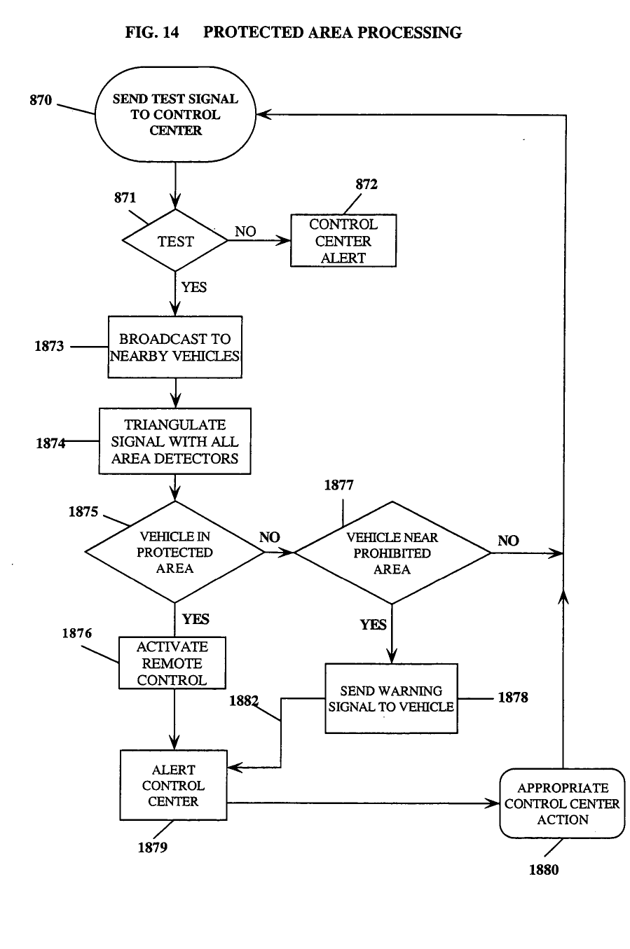

FIG. 14 depicts a logic diagram depicting the stepwise procedure of this embodiment of the present invention that relates to protected areas for surface vehicle dispatch and transportation and associated triggering events. A plurality of control centers should preferably be located in a series of secure, limited-access locations as the plurality of interconnected train cars traverse the boundaries of several states according to a pre-approved travel plan. Initially, as shown in step 870, a test signal is preferably transmitted to an appropriate control center to establish whether such communications apparatus is functioning as anticipated. If not, then, in step 872, an alert is generated at this control center to assure that this anomaly is immediately remedied. As hereinbefore elucidated, local train personnel should preferably use dedicated secure electronic apparatus and the like to continually communicate with a plurality of geographically distributed control centers. Suitable communications apparatus should be securely stored on board the train wherein input is received from a variety of monitoring sources including train security systems and alarms, train controls, and suitable train instrumentation. It will be appreciated that intelligence provided by such train instrumentation includes information pertaining to speed, direction, fuel, throttle, etc., and is broadcast to nearby vehicles (step 1873). This broadcast is triangulated, in step 874, to all detector apparatus disposed in the particular protected area as contemplated hereunder. As should be evident, this input is continuously relayed to the plurality of control centers for observation and monitoring operations effectuated by trained personnel who will initiate an appropriate immediate response, when and if necessary.

It will be understood that this communications apparatus directs communications between a plurality of control centers and the train's local control cutoff switch, which alternatively permits or prevents the train's engineer from operating the train using conventional local controls. Similarly, a secure communication means directs communications between a plurality of control centers and train controls, thereby triggering remote control of the train. Thus, still referring to FIG. 14, in step 1874, a determination is made whether any of the plurality of train cars has transgressed into a proximal protected area, or will imminently transgress into such protected area. If such occurrence has or will imminently occur, then, in step 1879, a control center alert should immediately be generated. On the other hand, if no such occurrence has or will imminently occur, then, in step 1877, a determination is preferably made whether such surface vehicles are apt to approach a protected area. If so, then, in step 1878, a control center warning signal should immediately be generated. This warning, of course, alerts the proximal control center (step 1879) and engenders, in step 1880, appropriate control center action.

It should also be clear that this secure communication means also enables remote activation of any fuel and/or energy cutoff valve, and railcar decoupling control means, as deemed appropriate under the circumstances by trained personnel. Ergo, depending upon the seriousness of circumstances related to the train's planned course, the condition and well-being of its crew and passengers, and the presence of hazardous cargo, it may be deemed necessary by security personnel to either effectuate cessation all power or a significant portion of such power, i.e., corresponding to prompt “fuel-release” via remote activation thereof. Thus, options include effective partial or complete cessation of power, separation of the engine from other railway train cars, and simultaneously remotely activating emergency braking of the coupled or decoupled railway cars.

Accordingly, the present invention contemplates that such secure communication means have the capability to enable the plurality of control centers to remotely activate and deactivate essentially automatic train operation. According to this embodiment of the present invention, the train, using the GPS or other positioning system, and conventional train dispatching means, communicates via a conventional communications means to continuously signal its location relative to the pre-approved, pre-planned course of travel. The plurality of trains and other surface vehicles would remain in contact with dispatch and appropriate authorities via a conventional communication means typified by radio-transponder communications or the like.

Suitable control communications would be established for effectuating secure communications between on-train secure communications apparatus and a plurality of secure control centers as hereinbefore described. Secure communication means continuously relay the signals generated from a railroad train's external apparatus to trained operators located in a series of control centers. If necessary, a plurality of override switches are remotely activated, thereby permitting disabling local on-train control cutoff switches.

It will be appreciated that a secure communication means also provides signals, alarms, and videos to alarm and monitor this apparatus. This alarm and monitor assembly enables operators to monitor conditions on any train—selected either randomly or in response to an alarm or to a suspicious circumstance. Secure communication apparatus also relays signals between the train and a train mock-up and train controls. The train mock-up and train controls receives all instrument data from the train, including video images indicating direction of travel, and a plurality of controls corresponding to the local controls. Operation of the train mock-up and train controls are triggered when the control override switch is activated, thereby circumventing the affect of the local driver controls disposed on the train.

It will be appreciated that the operation of the apparatus incorporated into the train embodiment having a plurality of train input monitors and alarms, representative of surface vehicles, is similar to the hereinbefore described airplane embodiment. Accordingly, representative inputs and alarms monitored by a control center alarm and monitor means may include a plurality of interior cameras which enable control center operators to monitor train activities. Such monitoring may include loss of tracking signal or the like. Similarly, a plurality of additional video cameras enable the control center operators and local train engineers and conductors to monitor passenger and cargo activities; the plurality of exterior video cameras depict the crucial direction-of-travel view for assisting control center operators remotely orchestrate safe train operation and, if necessary, safe stopping or directing the train to a secure protected area. Multiple panic alarms, located throughout the train allow passengers or crew to alert both the engineer and remote control centers regarding on-board disturbances and anomalous behavior.

All embodiments of the present invention should preferably include tamper detection means which should preferably be installed on the plurality of surface vehicles to detect unauthorized access to the on-board circuitry and the like. It should be evident that this may be implemented via a pressure switch that is activated when an access cover is removed or any of several means known in the art. It will be appreciated by those skilled in the art that an alphanumeric keypad may be used to input a security password to authenticate the engineer's identity prior to commencement of the trip. In addition, access to the on-board circuitry and the like should preferably be accessible only from the exterior of a train or like surface vehicle, preferably on the underside, thus making tampering impracticable while the train or like surface vehicle is in motion.

Similar to the step-wise procedure depicted in each of FIGS. 6 and 12, respectively, first, the train is located on its designated track, disabled by its local cutoff switch. It will be evident that the train is situated in its designated track after the completion of an authorized trip, and prior to receiving authorization to leave the track to commence a subsequent departing trip. Next, the engineer's identity is verified using a plurality of cockpit video cameras and a security keypad. If unauthorized attempts to activate the train persist, then a plurality of control centers will sustain the train's disabled state and simultaneously will notify local authorities to apprehend what appears to be an intruder.

Then, an authorized engineer will verify, in conjunction with personnel at a plurality of control centers, that all security devices and controls are in proper working order. If not, malfunctioning devices and controls should preferably be replaced or repaired, and the engineer ID be verified. If all security devices and controls are in proper order, the plurality of control centers will activate local control via deactivation of local control switch. Then, the trip will commence, and will continue to be monitored by the plurality of control centers. If a triggering event fails to occur, then the trip will conclude in due course, and the train is returned to the idle condition.

For such train embodiment, a plurality of control centers should preferably review accumulated security data to determine if invoking the remote control aspect of the present invention is merited. If invoking the remote control aspect of the present invention is merited, the plurality of control centers will take appropriate actions to safely control and direct the train to a secure protected area as contemplated hereunder. As will be appreciated by those skilled in the art, typical triggering events—that train embodiments of the present invention are designed to cause immediate responsive behavior to avert or minimize loss of life and destruction to a train and other property—include a panic alarm, an unauthorized and unexpected acceleration alarm, an unauthorized and unexpected speed alarm, an off-course alarm, an unauthorized passing of a red signal/stop alarm, an unauthorized passing of a yellow signal/cautionary deceleration alarm, a suspicious visual observations alarm, loss of video signals, and indication of tampering.

As hereinbefore described, the panic alarm may be activated by either a passenger or a crew member, or perhaps both. Assuming that a false alarm has not occurred, the cause of the alarming condition must be immediately ascertained. Of course, triggering a tamper detector alarm indicates that an intruder is afoot and is threatening the integrity of the anti-hijacking system taught by the present invention.

It should be clear to those skilled in the art that triggering of an off-course alarm, which may obtain from a GPS or other positioning system or from the dispatching center, is indicative of the train deviating from its course; instantaneous remedial action should be instigated. A passed red and/or yellow signal alarm could indicate the authorized engineer's loss of control due to incapacity, or actions of an intruder. An acceleration alarm could indicate an emergency maneuver or indicate the engineer's loss of control due to damage to the train.

Visual observations from any of the plurality of interior video cameras would constitute a trigger of a responsive action that must be taken forthwith to address a disturbance on the train. Similarly, visual observations from the plurality of exterior video cameras could indicate that there is an obstacle in the train's path and that immediate remedial action must be taken. Loss of interior video could indicate that a terrorist hijacker is obscuring or disabling the plurality of cameras to conceal their dastardly actions. Another triggering event would be loss of signal that would indicate a malfunction or tampering with the train's functions. According to the present invention, such loss of signal could trigger immediate control of the train by the control center and any other appropriate actions such as a police or military escort back to a secure area.

It should be clear that a specific surface vehicle embodiment of the present invention may readily be adapted to prevent hijacking of seaworthy vessels traversing the seas, under the influence of plurality of control centers contemplated by the present invention. As will be understood by those skilled in the art, this embodiment also contemplates exploiting the GPS or other real-time or near-real-time positioning means known in the art to monitor the progress and attitude of a ship in real-time or near-real-time relative to its panoply of departure parameters, pre-approved course plan, arrival parameters, and any other relevant travel and shipping parameters. The plurality of control centers should preferably be located in secure, limited-access locations, such as military bases and nondescript vessels at-sea, and should preferably use dedicated secure electronic apparatus and the like.

It will be understood that the apparatus incorporated into the plurality of vessel input monitors and alarms may include a plurality of bridge interior cameras which enable control center operators to monitor bridge activities. Such monitoring may include loss of tracking signal or the like. Similarly, a plurality of additional video cameras enable the control center operators and local pilots to monitor deck, engineering, passenger, and cargo activities. It should be clear that a plurality of exterior video cameras depict the crucial direction-of-travel view for assisting control center operators remotely orchestrate safe vessel operation and, if necessary, safe return to port and docking thereof. Multiple panic alarms are located throughput the vessel to allow passengers or crew to alert both the pilot and control centers regarding on-board disturbances.

As will be appreciated by those skilled in the art, the on-board communications apparatus receive input from a variety of monitoring sources including vessel security systems and alarms, vessel controls, and vessel instrumentation. It will be appreciated that intelligence provided by such instrumentation includes information pertaining to speed, direction, power, throttle, etc. This input received by a suitable communications apparatus is relayed to a plurality of control centers for observation and monitoring operations that will trigger an appropriate immediate response, when and if necessary.

It will be understood that this communications apparatus directs communications between the plurality of control centers and vessel local control cutoff switching apparatus, which alternatively permits or prevents the captain or his officers from operating a vessel using conventional local controls. Similarly, the secure communication means directs communications between the plurality of control centers and vessel controls, thereby triggering remote control thereof.

It will be understood, from a logistics vantage point that a stepwise procedure that relates to ship operations should be implemented akin to the hereinbefore described procedure implemented for airplane and other surface vehicle operations. Accordingly, such vessel is berthed in its designated slip, preferably disabled by a local cutoff switch. It will be evident that the vessel is situated in its designated anchored location after the completion of an authorized voyage, and prior to receiving authorization to depart upon a subsequent voyage. The identity of the captain and officers is verified using a plurality of bridge video cameras, a security keypad, and other biometrics devices, if appropriate, for identification purposes. If unauthorized attempts to activate the vessel persist, then a plurality of control centers will sustain the vessel's disabled state and simultaneously notify local authorities to apprehend what appears to be unauthorized and perhaps terrorist activity.

The captain or another authorized officers will verify, in conjunction with personnel at a plurality of control centers, that all security devices and controls are in proper working order. If not, malfunctioning devices and controls should preferably be replaced or repaired, and the captain's ID be verified. If all security devices and controls are in proper order, the plurality of control centers will activate local control via deactivation of a local control switch means. Then, the voyage will commence, and will continue to be monitored by the plurality of control centers. If a triggering event fails to occur, then the voyage will conclude in due course, and the ship will be returned to the idle docked condition.

Other variations and modifications will, of course, become apparent from a consideration of the structures and techniques hereinbefore described and depicted. Accordingly, it should be clearly understood that the present invention is not intended to be limited by the particular features and structures hereinbefore described and depicted in the accompanying drawings, and that the examples recited herein are intended to illustrate the underlying concepts and are not intended to constitute a limitation thereof. The present invention is to be measured by the scope of the appended claims.

What is claimed is:

1. An override protocol system for assuming control and operation of an airplane operated by a pilot using conventional communication means to communicate with conventional local flight controls including a proximity transponder, an autopilot, and a local control cutoff switch, said override protocol system comprising:
said airplane traversing predetermined airspace, according to an approved flight plan, separate from a plurality of protected areas that are geographically disposed in a corresponding plurality of secure, limited-access locations isolated from any form of intrusion;
an override means for remotely taking control of said airplane;
a plurality of monitoring sensors disposed upon and throughout said airplane for generating signals for indicating that an exigent circumstance is occurring upon or within said airplane;
control means for analyzing said generated signals and for triggering immediate corrective action to remotely override control of said airplane;
a plurality of flight control centers disposed within said plurality of protected areas;
a plurality of air traffic control centers disposed throughout said airspace and spatially related to said plurality of flight control centers;
a secure communications apparatus disposed on-board said airplane for communicating and cooperatively interacting with said plurality of secure communications apparatus located at said plurality of control centers and at said plurality of protected areas; and
said secure communications apparatus including positioning means for monitoring the progress and attitude of said airplane as it traverses said airspace.

2. The override protocol system recited in claim 1, wherein said plurality of flight control centers uses dedicated secure electronic apparatus for routine insulation from penetration by unauthorized personnel and by unauthorized electronic transactions, and from tampering by any personnel or electronic transactions.

3. The override protocol system recited in claim 2, wherein said plurality of flight control centers is operated by properly trained personnel with sufficiently high security clearance.

4. The override protocol system recited in claim 3, wherein said dedicated secure electronic apparatus are separate and distinct from air traffic control operations and concomitant personnel who operate the conventional air traffic control system.

5. The override protocol system recited in claim 4, wherein said secure communications apparatus receives input from a variety of monitoring sources for providing intelligence pertaining to speed, direction, fuel, and throttle of said airplane for being relayed to said plurality of control centers, for prompt observation and monitoring operations that trigger an appropriate immediate response, when and if necessary.

6. The override protocol system recited in claim 5, wherein said variety of monitoring sources includes airplane security systems and alarms, airplane controls, and airplane instrumentation.

7. The override protocol system recited in claim 6, wherein said immediate corrective action includes disabling said airplane.

8. The override protocol system recited in claim 6, wherein said immediate corrective action includes dumping fuel from said airplane.

9. The override protocol system recited in claim 6, wherein said immediate corrective action includes engine-shutdown of said airplane.

10. The override protocol system recited in claim 1, wherein said secure communications apparatus controls and manages communications between said plurality of protected areas and said airplane proximity transponder, which causes automatic activation of said airplane automatic autopilot, when and if, said aircraft encroaches upon said plurality of protected areas.

11. The override protocol system recited in claim 10, wherein said automatic autopilot directs said airplane away from said plurality of protected areas and simultaneously alerts said plurality of control centers about said corrective action incident.

12. The override protocol system recited in claim 11, wherein said secure communications apparatus directs communications between said plurality of control centers and said local control cutoff switch, which alternatively permits or prevents said pilot from operating said airplane using said conventional local flight controls.

13. The override protocol system recited in claim 12, wherein said secure communication apparatus directs communications between said plurality of control centers and said airplane controls, thereby triggering remote control of said airplane.

14. The override protocol system recited in claim 12, wherein said secure communication apparatus directs communications between said plurality of control centers and said airplane controls, thereby triggering remote activation of said fuel release control of said airplane.

15. The override protocol system recited in claim 12, wherein said triggering remote activation of said fuel release control of said airplane causes said security personnel to promptly release all fuel or excess fuel depending upon the seriousness of circumstances related to said airplane's flight pattern and the condition and well-being of its crew and passengers, and the presence of hazardous cargo.

16. The override protocol system recited in claim 12, wherein said secure communication means enables said plurality of control centers to remotely activate and deactivate said automatic autopilot.

17. The override protocol system recited in claim 1, wherein said positioning means, said airplane, and said air traffic control communicate via said conventional communication means to determine changing location and progress of said airplane relative to its said approved flight plan.

18. The override protocol system recited in claim 1, wherein said positioning means monitors in real-time said progress and said attitude of said airplane as it traverses said airspace.

19. The override protocol system recited in claim 1, wherein said positioning means monitors in near-real-time said progress and said attitude of said airplane as it traverses said airspace.

20. An override protocol system for assuming control and operation of a surface vehicle operated by an operator using conventional communication means to communicate with conventional local travel controls including a proximity transponder, an autopilot, and a local control cutoff switch, said override protocol system comprising:
said surface vehicle traversing predetermined land and water territory, according to an approved travel plan, separate from a plurality of protected areas that are geographically disposed in a corresponding plurality of secure, limited-access locations isolated from any form of intrusion;
an override means for remotely taking control of said surface vehicle;
a plurality of monitoring sensors disposed upon and throughout said surface vehicle for generating signals for indicating that an exigent circumstance is occurring upon or within said surface vehicle;
control means for analyzing said generated signals and for triggering immediate corrective action to remotely override control of said surface vehicle;
a plurality of travel control centers disposed within said plurality of protected areas;
a plurality of transportation control centers disposed throughout said land and water territory and spatially related to said plurality of transportation control centers;
a secure communications apparatus disposed on-board said surface vehicle for communicating and cooperatively interacting with said plurality of secure communications apparatus located at said plurality of control centers and at said plurality of protected areas; and
said secure communications apparatus including positioning means for monitoring the progress and location of said surface vehicle as it traverses said land and water territory.

21. The override protocol system recited in claim 20, wherein said plurality of travel control centers uses dedicated secure electronic apparatus for routine insulation from penetration by unauthorized personnel and by unauthorized electronic transactions, and from tampering by any personnel or electronic transactions.

22. The override protocol system recited in claim 21, wherein said plurality of transportation control centers is operated by properly trained personnel with sufficiently high security clearance.

23. The override protocol system recited in claim 22, wherein said dedicated secure electronic apparatus are separate and distinct from transportation control operations and concomitant personnel who operate the conventional transportation control system.

24. The override protocol system recited in claim 23, wherein said secure communications apparatus receives input from a variety of monitoring sources for providing intelligence pertaining to speed, direction, fuel, and throttle of said surface vehicle for being relayed to said plurality of control centers, for prompt observation and monitoring operations that trigger an appropriate immediate response, when and if necessary.

25. The override protocol system recited in claim 24, wherein said variety of monitoring sources includes surface vehicle security systems and alarms, surface vehicle controls, and surface vehicle instrumentation.

26. The override protocol system recited in claim 25, wherein said immediate corrective action includes disabling said surface vehicle.

27. The override protocol system recited in claim 25, wherein said immediate corrective action includes dumping fuel from or reducing power to said surface vehicle.

28. The override protocol system recited in claim 25, wherein said immediate corrective action includes engine-shutdown of said surface vehicle.

29. The override protocol system recited in claim 20, wherein said secure communications apparatus controls and manages communications between said plurality of protected areas and said surface vehicle proximity transponder, which causes automatic activation of said surface vehicle automatic autopilot, when and if, said surface vehicle encroaches upon said plurality of protected areas.

30. The override protocol system recited in claim 29, wherein said automatic autopilot directs said surface vehicle away from said plurality of protected areas and simultaneously alerts said plurality of control centers about said corrective action incident.

31. The override protocol system recited in claim 30, wherein said secure communications apparatus directs communications between said plurality of control centers and said local control cutoff switch, which alternatively permits or prevents said operator from operating said surface vehicle using said conventional local travel controls.

32. The override protocol system recited in claim 31, wherein said secure communication apparatus directs communications between said plurality of control centers and said surface vehicle controls, thereby triggering remote control of said surface vehicle.

33. The override protocol system recited in claim 31, wherein said secure communication apparatus directs communications between said plurality of control centers and said surface vehicle controls, thereby triggering remote activation of said fuel release or power reduction control to cease operation of said surface vehicle.

34. The override protocol system recited in claim 31, wherein said triggering remote activation of said fuel release or power reduction control of said surface vehicle causes said security personnel to promptly release all fuel or power, or excess fuel or power, depending upon the seriousness of circumstances related to said surface vehicle's travel pattern and the condition and well-being of its crew and passengers, and the presence of hazardous cargo.

35. The override protocol system recited in claim 31, wherein said secure communication means enables said plurality of control centers to remotely activate and deactivate said automatic autopilot.

36. The override protocol system recited in claim 20, wherein said positioning means, said surface vehicle, and said transportation control communicate via said conventional communication means to determine changing location and progress of said surface vehicle relative to its said approved travel plan.

37. The override protocol system recited in claim 20, wherein said positioning means monitors in real-time said progress and said location of said surface vehicle as it traverses said land and water territory.

38. The override protocol system recited in claim 20, wherein said positioning means monitors in near-real-time said progress and said location of said surface vehicle as it traverses said land and water territory.
